(19) United States
(12) Patent Application Publication
(10) Pub. No.: US 2025/0299150 A1
(43) Pub. Date: Sep. 25, 2025

(54) DELIVERY ROBOT SERVICE PROVIDER AND METHOD OF OPERATION THEREOF

(71) Applicant: Electronics and Telecommunications Research Institute, Daejeon (KR)

(72) Inventors: Taehyoung SHIM, Sejong-si (KR); Jun Seob LEE, Daejeon (KR); Jeongil YIM, Daejeon (KR)

(73) Assignee: Electronics and Telecommunications Research Institute, Daejeon (KR)

(21) Appl. No.: 19/085,533

(22) Filed: Mar. 20, 2025

(30) Foreign Application Priority Data
Mar. 20, 2024 (KR) 10-2024-0038458
Apr. 23, 2024 (KR) 10-2024-0053994
Mar. 17, 2025 (KR) 10-2025-0033862

(51) Int. Cl. G06Q 10/0833; G05D 1/698

(52) U.S. Cl. CPC G06Q 10/0833; G05D 1/698

(57) ABSTRACT

A delivery robot service provider and an operating method thereof are disclosed. The operating method of the delivery robot service provider includes receiving a delivery request from a user device, generating delivery information on the delivery request, assigning a delivery robot that performs the delivery request, transmitting the delivery information to the delivery robot, and sharing a current location of the delivery robot and a loading status of goods with the delivery robot service provider while the delivery robot is delivering the goods according to the delivery information.

### TECHNICAL FIELD

The following disclosure relates to a delivery robot service provider and an operating method thereof.

### BACKGROUND OF THE INVENTION

An autonomous delivery robot service may be a service where delivery robots deliver goods by interworking with urban infrastructure and other entities.

For the autonomous delivery robot service, an interworking protocol between the entities (e.g., delivery robots, service providers, users, or infrastructure) may be required.

The above description has been possessed or acquired by the inventor(s) in the course of conceiving the present disclosure and is not necessarily an art publicly known before the present application is filed.

### DISCLOSURE OF THE INVENTION

### Technical Goals

An aspect provides an interworking method for an autonomous robot-based delivery service.

However, technical aspects are not limited to the foregoing aspect, and there may be other technical aspects.

### Technical Solutions

According to an embodiment, an operating method of a delivery robot service provider includes receiving a delivery request from a user device, generating delivery information on the delivery request, assigning a delivery robot that performs the delivery request, transmitting the delivery information to the delivery robot, and sharing a current location of the delivery robot and a loading status of goods with the delivery robot service provider while the delivery robot is delivering the goods according to the delivery information.

The delivery information may include at least one of a pick-up location of the goods, a delivery location of the goods, a delivery time of the goods, information on an infrastructure that the delivery robot needs to interwork with for the delivery of the goods, a delivery route of the goods, and a type of the goods.

The delivery robot service provider may retain information on an infrastructure that interworks with the delivery robot.

The operating method may further include interworking with an infrastructure located on a delivery route of the goods.

The operating method may further include determining an access priority to the infrastructure between the delivery robot and another delivery robot based on a presence of the other delivery robot competing with the delivery robot to access the infrastructure.

The determining may include determining the access priority by interworking with another delivery robot service provider when the other delivery robot is managed by the other delivery robot service provider.

The operating method may further include transmitting a loading status of the goods or an unloading status of the goods to a corresponding user device.

According to an embodiment, an apparatus for managing a delivery robot includes a processor and a memory storing instructions, in which, when the instructions are executed by the processor, the instructions cause the apparatus to perform a plurality of operations, and the plurality of operations includes receiving a delivery request from a user device, generating delivery information on the delivery request, assigning a delivery robot performing the delivery request, transmitting the delivery information to the delivery robot, and sharing a current location of the delivery robot and a loading status of goods with the delivery robot service provider while the delivery robot is delivering the goods according to the delivery information.

The delivery information may include at least one of a pick-up location of the goods, a delivery location of the goods, a delivery time of the goods, information on an infrastructure that the delivery robot needs to interwork with for the delivery of the goods, a delivery route of the goods, and a type of the goods.

The apparatus may retain information on an infrastructure that interworks with the delivery robot.

The plurality of operations may further include interworking with infrastructure located on a delivery route of the goods.

The plurality of operations may further include determining an access priority to the infrastructure between the delivery robot and another delivery robot based on a presence of the other delivery robot competing with the delivery robot to access the infrastructure.

The determining may include determining the access priority by interworking with another delivery robot service provider when the other delivery robot is managed by the other delivery robot service provider.

The plurality of operations may further include transmitting a loading status of the goods or an unloading status of the goods to a corresponding user device.

### BRIEF DESCRIPTION OF DRAWINGS

FIG. 1 is a diagram illustrating a delivery service system according to an embodiment.

FIG. 2 is a drawing illustrating a delivery robot service provider according to an embodiment.

FIG. 3 is a diagram illustrating a delivery robot according to an embodiment.

FIG. 4 is a diagram illustrating an urban infrastructure according to an embodiment.

FIG. 5 is a diagram illustrating a user device according to an embodiment.

FIG. 6 illustrates a workflow for a delivery request and a delivery start in a user device according to an embodiment.

FIG. 7 illustrates a workflow for receiving a notification on completion of loading goods from a delivery robot according to an embodiment.

FIG. 8 illustrates a workflow for receiving a notification on completion of unloading goods from a delivery robot according to an embodiment.

FIG. 9 illustrates a workflow for receiving a notification on completion of loading goods in a user device according to an embodiment.

FIG. 10 illustrates a workflow for receiving a notification on completion of unloading goods in a user device according to an embodiment.

FIG. 11 illustrates a workflow for interworking between a delivery robot and an urban infrastructure according to an embodiment.

FIG. 12 illustrates a workflow for interworking between a delivery robot and an urban infrastructure according to an embodiment.

FIG. 13 is a schematic block diagram illustrating an apparatus according to an embodiment.

### BEST MODE FOR CARRYING OUT THE INVENTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables.

The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the examples with reference to the accompanying drawings, like reference numerals refer to like components and a repeated description related thereto will be omitted.

In this specification, “Functions” may be defined as a collection of functionalities, and a “functional entity (FE)” may be defined as a representation of a functionality that is not further specified at the detailed level described herein.

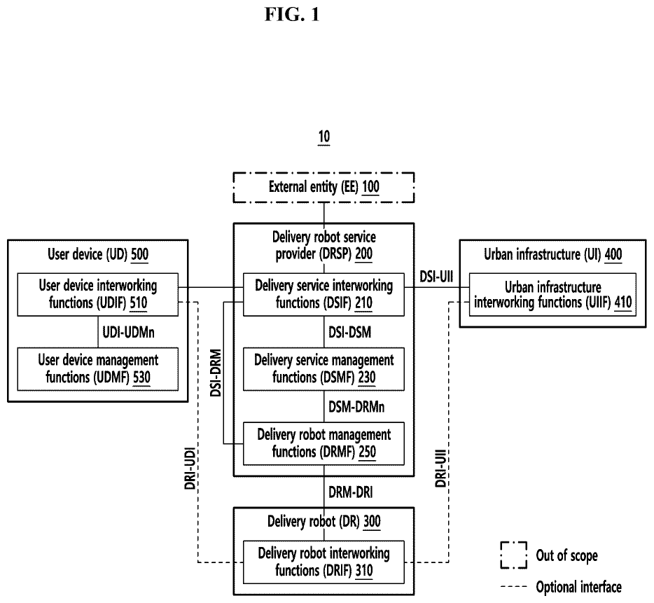

FIG. 1 is a diagram illustrating a delivery service system according to an embodiment. Referring to FIG. 1, a delivery service system 10 may include a delivery robot service provider (DRSP) 200, a delivery robot (DR) 300, an urban infrastructure (UI) 400, a user device (UD) 500, and an external entity (EE) 100.

The DRSP 200 may include a delivery service interworking function (DSIF) 210, a delivery service management function (DSMF) 230, and a delivery robot management function (DRMF) 250.

The DR 300 may include a delivery robot interworking function (DRIF) 310.

The UI 400 may include an urban infrastructure interworking function (UIIF) 410.

The UD 500 may include a user device interworking function (UDIF) 510 and a user device management function (UDMF) 530.

The EE 100 may include a device (e.g., a server) of a public institution (e.g., an urban control center, a disaster management agency, or an emergency rescue agency) and a device (e.g., a server) of another delivery robot service provider. The EE 100 may interwork directly with the DRSP 200.

In the delivery service system 10, interfaces for a delivery service may include DSI-DRM, DSI-DRM, DSI-UDI, DSI-UII, DSM-DRMn, DRM-DRI, DRI-UDI, DRI-UII, and UDI-UDMn. The DSI-DSM may be an interface between an FE of the DSIF 210 and an FE of the DSMF 230. The DSI-DRM may be an interface between the FE of the DSIF 210 and an FE of the DRMF 250. The DSI-UDI may be an interface between the FE of the DSIF 210 and an FE of the UDIF 510. The DSI-UII may be an interface between the FE of the DSIF 210 and an FE of the UIIF 410. The DSM-DRMn may be an interface between the FE of the DSIF 210 and the FE of the DRMF 250. The DRM-DRI may be an interface between the FE of the DRMF 250 and an FE of the DRIF 310. The DRI-UDI may be an interface between the FE of the DRIF 310 and the FE of the UDIF 510. The DRI-UII may be an interface between the FE of the DRIF 310 and the FE of the UIIF 410. The UDI-UDMn may be an interface between the FE of the UDIF 510 and an FE of the UDMF 530.

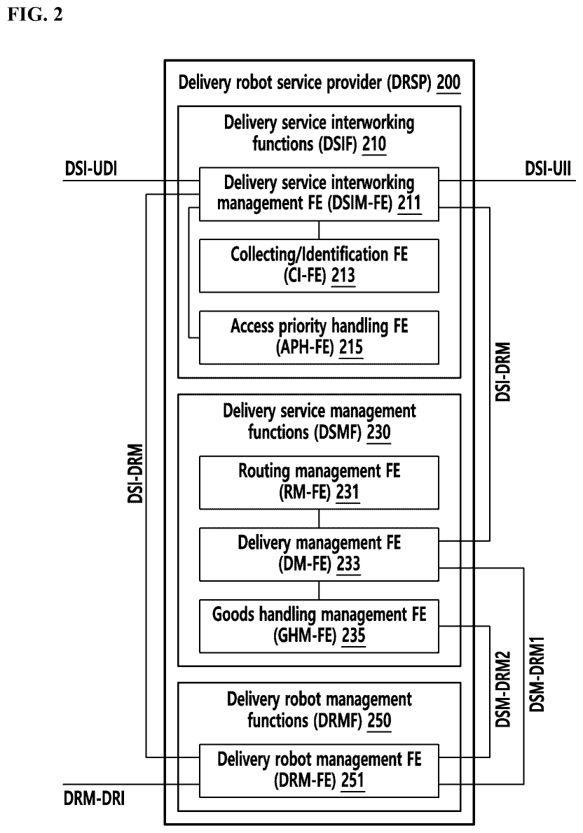

FIG. 2 is a drawing illustrating a delivery robot service provider according to an embodiment.

Referring to FIG. 2, the DRSP 200 may be implemented as a device, such as a server. The DRSP 200 may manage the DR 300. The DRSP 200 may interwork directly with the DR 300, the UI 400, the UD 500, and the EE 100. The DRSP 200 may retain and/or manage information (e.g., identifier or capability) on the DR 300. The DRSP 200 may collect and manage information (e.g., identifier, capability, or location) on the UI 400.

In response to receiving a delivery request from the UD 500, the DRSP 200 may determine whether there is an available delivery robot (e.g., the DR 300). The DRSP 200 may transmit information (e.g., delivery request approval or delivery request rejection) to the UD 500, based on the available delivery robot.

The DRSP 200 may identify one or more user devices related to the received delivery request. For example, the DRSP 200 may identify a user device of a delivery requester, a user device related to the loading of goods, and a user device (e.g., a user device of a receiver) related to the unloading of the goods.

The DRSP 200 may generate delivery information on a delivery request. The delivery information may include at least one of a pick-up location, a delivery location, a delivery time, information (e.g., identifier or location) on infrastructure that needs to interwork with a delivery robot, a delivery route, the type of goods, the weight of the goods, the size of the goods, and a delivery condition (e.g., a proper temperature).

The DRSP 200 may assign the DR 300 simultaneously with or separately from generating a delivery request.

The DRSP 200 may collect the current location of the DR 300, a movement direction of the DR 300, a status (e.g., breakdown or a battery state) of the DR 300, a goods loading status of the DR 300, or a status (e.g., a temperature) of the goods.

The DRSP 200 may transmit delivery status information generated by the DR 300 to the UD 500.

The DRSP 200 may notify the UD 500 that the DR 300 is waiting to load or unload the goods after the DR 300 arrives at the pick-up location or the delivery location.

After the DR 300 arrives at the UI 400, the DRSP 200 may notify the UI 400 that the DR 300 is waiting to interwork with the UI 400.

The DRSP 200 may notify the DR 300 of a response (e.g., a result of an interworking request) to the interworking request received from the UI 400.

The DRSP 200 may collect additional information other than the delivery information from the UI 400 and/or the EE 100. The DRSP 200 may provide the collected additional information to the DR 300.

The DRSP 200 may receive information indicating that the loading or unloading of the goods is completed from the UD 500. The DRSP 200 may transmit the received information to the DR 300.

The DRSP 200 may receive information indicating that the loading or unloading of the goods is completed from the DR 300. The DRSP 200 may transmit the received information to the UD 500.

The DRSP 200 may determine whether the DR 300 may continue to deliver the goods, based on the delivery status information generated by the DR 300.

The DRSP 200 may receive a result of direct interworking from the DR 300. The DRSP 200 may update the delivery information in response to receiving the result.

The DRSP 200 may receive a request from the EE 100. For example, the EE 100 may request the DRSP 200 to transmit visual information on a space surrounding the DR 300. The DRSP 200 may evaluate (or determine) the request (e.g., the content of the request) from the EE 100. The DRSP 200 may divide the request from the EE 100 into an urgent request and a non-urgent request. The DRSP 200 may notify the DR 300 of the request from the EE 100. For example, when the request from the EE 100 needs to be processed preferentially, the DRSP 200 may transmit priority information of the request together with the request from the EE 100 to the DR 300.

The DRSP 200 may process the request from the EE 100 and may notify the EE 100 of a processing result.

The DRSP 200 may determine a priority among a plurality of delivery robots when the plurality of delivery robots is waiting to interwork with the same urban infrastructure. The priority may be an order for the plurality of delivery robots to use the urban infrastructure. The DRSP 200 may use the delivery status information (e.g., the type of goods or a status of the goods) of each of the plurality of delivery robots to determine the priority.

The DRSP 200 may receive a result of interworking (e.g., direct interworking) between the DR 300 and another delivery robot (e.g., another delivery robot 21) from the DR 300. The DRSP 200 may determine, from the received result, that the other delivery robot is managed by another delivery service provider. The DRSP 300 may determine, from the received result, that the DR 300 and the other delivery robot 21 are waiting to interwork with the same urban infrastructure. The DRSP 200 may interwork with the other delivery robot service provider to coordinate a priority between the DR 300 and the other delivery robot.

The DRSP 200 may transform a certain coordinate system (e.g., a cartesian coordinate system) into another coordinate system (e.g., a spherical coordinate system). The DRSP 200 may identify the current location of the DR 300 by using an appropriate coordinate system. The DRSP 200 may use an appropriate coordinate system to assist an operation (e.g., the loading and unloading of the goods or access to the UI 400) of the DR 300. The DRSP 200 may use an appropriate coordinate system to exchange information with the other delivery robot service provider.

The DRSP 200 may include a delivery service interworking function (DSIF) 210, a delivery service management function (DSMF) 230, and a delivery robot management function (DRMF) 250.

In the DRSP 200, interfaces for a delivery service may include DSI-DSM1, DSI-DRM, DSI-UII, DSI-UDI, DSM-DRM1, DSM-DRM2, and DRM-DRI. The DSI-DSM1 may be an interface between a delivery service interworking management functional entity (DSIM-FE) 211 and a delivery management functional entity (DM-FE) 233. The DSI-DRM may be an interface between the DSIM-FE 211 and a delivery robot management functional entity (DRM-FE) 251. The DSI-UII may be an interface between the DSIM-FE 211 and a UIIM-FE 411. The DSI-UDI may be an interface between the DSIM-FE 211 and a UDIM-FE 511. The DSM-RM1 may be an interface between the DM-FE 233 and the DRM-FE 251. The DSM-DRM2 may be an interface between a goods handling management functional entity (GHM-FE) 235 and the DRM-FE 251. The DRM-DRI may be an interface between the DRM-FE 251 and a delivery robot interworking management functional entity (DRIM-FE) 311.

The DSIF 210 provides functions for interworking with the UI 400, the UD 500, the DSMF 230, and the DRMF 250. The DSIF 210 may interwork with the DSMF 230, the DRMF 250, the UIIF 410 of a UI, and the UDIF 510 of a UD. The DSIF 210 may include the DSIM-FE 211, a collection/identification functional entity (CI-FE) 213, and an access priority handling functional entity (APH-FE) 215.

The DSIM-FE 211 may perform an operation related to delivery service interworking management. For example, the operation related to delivery service interworking management may include the followings:
receiving (requesting) a delivery request from the UD 500 and responding (requesting) the delivery request from the UD 500;
requesting to determine whether a delivery robot may be assigned to the DRMF 250;
notifying the UI 400 when the DR 300 is waiting to access the UI 400;
receiving an access request result from the UI 400 to the DR 300;
notifying the DR 300 after evaluating a request received from the EE 100; and
notifying the EE 100 of a processing result when a response is required for the request.

The CI-FE 213 may perform an operation related to collection/identification. For example, the operation related to collection/identification may include:
identifying (requesting/forwarding/receiving) the UD 500;
collecting additional delivery information from the UI 400 or the EE 100 and providing it to the DR 300; and
collecting information, such as identifier, capability, and location, on the UI 400.

The APH-FE 215 may perform an operation related to access priority processing. For example, the operation related to access priority processing may include:
determining an access priority of the UI 400 for the DR 300.

The DSMF 230 may interwork with the DSIF 210 and the DRMF 250. The DSMF 230 may include a routing management functional entity (RM-FE) 231, the DM-FE 233, and the GHM-FE 235.
The RM-FE 231 may perform an operation related to routing management. For example, the operation related to routing management may include:
generating delivery route information including a pick-up/delivery location, a delivery time, and a UI 400 location; and
transforming between different coordinate systems.

The DM-FE 233 may perform an operation related to delivery management. For example, the operation related to delivery management may include:
requesting delivery route information from the RM-FE 231;
generating delivery information;
generating goods information;
notifying the DRMF250 of the delivery information;
monitoring a delivery status and a goods status;
notifying the UD 500 of the delivery status during delivery; and
updating the delivery status upon receiving a result of direct interworking with the UD 500 or the UI 400 from the DR 300.

The GHM-FE 235 may perform an operation related to goods handling management. For example, the operation related to goods handling management may include:
receiving a goods handling request message from the DR 300;
notifying the UD 500 when the DR 300 is waiting to load/unload goods at a pick-up location or a delivery location;
notifying the UD 500 of the completion of the loading/unloading of the goods when the goods are received from the DR 300; and
notifying the DR 300 of the completion of the loading/unloading of the goods when the goods are received from the UD 500.

The DRMF 250 may include the DRM-FE 251. The DRM-FE 251 may perform an operation related to DR management. For example, the operation related to DR management may include:
maintaining registration of information on the DR 300, such as identifier and capability;
determining (or confirming) whether the DR 300 may be assigned to a delivery request;
notifying a specified DR 300 of delivery information;
monitoring the DR 300; and
determining (or confirming) whether the DR 300 may continue to deliver goods from delivery goods information.

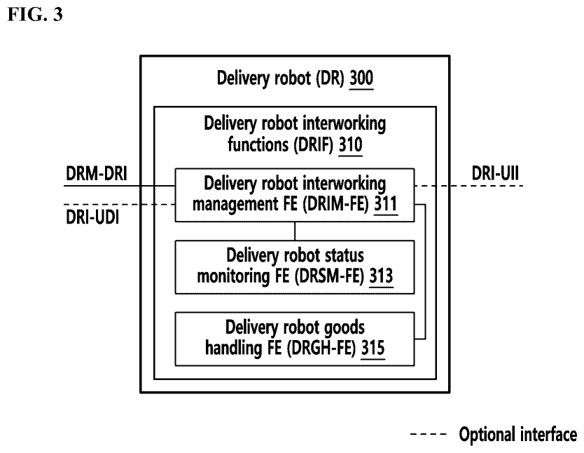

FIG. 3 is a diagram illustrating a delivery robot according to an embodiment.

The DR 300 may deliver goods based on a delivery request of a user. The DR 300 may include an autonomous driving-based robot. The DR 300 may interwork directly with the UD 500, the DRSP 200, and the UI 400. The DR 300 may interwork indirectly with an external entity 15 via the DRSP 200.

The DR 300 may share information (e.g., identifier or capability) on the DR 300 with the DRSP 200.

The DR 300 may share delivery status information (e.g., the current location of the DR 300, a goods loading status, the type of goods, a status of the goods) with the DRSP 200.

The DR 300 may identify one or more user devices related to the goods to be delivered. For example, the DR 300 may identify a user device related to the loading of the goods and a user device (e.g., a user device of a receiver) related to the unloading of the goods.

When the goods are loaded or unloaded by an object (e.g., a person or another robot) that is not the DR 300, the DR 300 may notify the DRSP 200 that the DR 300 is waiting to load or unload the goods after arriving at a pick-up location or a delivery location.

The DR 300 may receive information indicating that the loading or the unloading is completed from the object (e.g., the person or the other robot) responsible for the loading or unloading of the goods. After receiving the information, the DR 300 may notify the DRSP 200 that the loading or the unloading is completed.

When the goods are loaded or unloaded by the DR 300, the DR 300 may notify the DRSP 200 that the loading or the unloading is completed after completing the loading or unloading of the goods.

After arriving at the UI 400, the DR 300 may notify the DRSP 200 that the DR 300 is waiting to access the UI 400.

The DR 300 may request the DRSP 200 to transmit additional information required to access the UI 400 or for autonomous driving.

The DR 300 may maintain time synchronization with the DRSP 200.

When an event (e.g., a breakdown of the DR 300) that may impede delivery occurs, the DR 300 may notify the DRSP 200 of information related to the event. The DR 300 may take actions necessary to tackle the event.

The DR 300 may interwork directly with the UD 500, the UI 400, and another delivery robot, as needed. For example, the DR 300 may interwork directly with the other delivery robot when a collision with the other delivery robot that is within a preset distance (or a distance sensible by a sensor) from the DR 300 is predicted. The DR 300 may interwork directly with the other delivery robot when congestion caused due to the sharing of a narrow space (e.g., a staircase) between the DR 300 and the other delivery robot is predicted. The DR 300 may calculate a congestion level based on at least one of the area of a space surrounding the DR 300, the type of the space surrounding the DR 300, the size of the DR 300, and the size of the other delivery robot. For example, the DR 300 may determine the congestion level to be higher as the space (e.g., an elevator) surrounding the DR 300 is more likely to be occupied by people. The DR 300 may interwork directly with the other delivery robot when the congestion level satisfies a threshold. The DR 300 may interwork directly with the UI 400 when a failure occurs in communication with the DRSP 200. The DR 300 may interwork directly with the UD 500 when the DR 300 needs to approach the UD 500, or user authentication is required.

The DR 300 may notify a result of the direct interworking to the DRSP 200.

The DR 300 may interwork with the other delivery robot via the DRSP 200.

The DR 300 may receive a request from the DRSP 200 to process a specific task preferentially. The DR 300 may process the requested task preferentially. The DR 300 may transmit a processing result of the requested task to the DRSP 200.

The DR 300 may include the DRIF 310. In the DR 300, interfaces for a delivery service may include DRM-DRI, DRI-UII, and DRI-UDI. The DRM-DRI may be an interface between the DRIM-FE 311 and the DRM-FE 251. The DRI-UII may be an interface between the DRIM-FE 311 and the UIIM-FE 411. The DRI-UDI may be an interface between the DRIM-FE 311 and the UDIM-FE 511.

The DRIF 310 may provide a function for interworking with the DRSP 200, the UI 400, and the UD 500. The DRIF 310 may interwork with the DRMF 250 in the DRSP 200, the UIIF 410 of the UI 400, and the UDIF 510 of the UD 500.

The DRIF 310 may include the DRIM-FE 311, a delivery robot status monitoring functional entity (DRSM-FE) 313, and a delivery robot goods handling functional entity (DRGH-FE) 315.

The DRIM-FE 311 may perform an operation related to DR interworking management. For example, the operation related to DR interoperability management may include:
Receiving delivery information from the DRSP 200;
Generating a result of direct interworking with the UD 500 or the UI 400;
notifying the DRSP 200 of an interworking result when interconnecting directly with the UD 500, the UI 400, and another DR in a near field;
sharing identifier and capability information with the DRSP 200;
identifying (forwarding/receiving) the UD 500;
notifying the DRSP 200 when the DR 300 arrives at the UI 400;
requesting updated delivery information from the DRSP 200 during self-driving or while accessing the UI 400, if necessary;
notifying the DRSP 200 of a delivery status and a goods status;
maintaining time synchronization with the DRSP 200;
identifying the other DR;
interworking indirectly with the other DR via the DRSP 200;
interworking directly with the UD 500, the UI 400, and the DR 300 in a near field; and
prioritizing and processing a priority processing request when receiving a request (e.g., the priority processing request) from the DRSP 200.

The DRSM-FE 313 may perform an operation related to DR status monitoring. For example, the operation related to DR status monitoring may include:
collecting a delivery status (e.g., a current heading and location of a DR, a robot status, and a battery status); and
notifying the DRSP 200 immediately of an exception, such as a breakdown.

The DRGH-FE 315 may perform an operation related to goods handling. For example, the operation related to goods handling may include:
collecting a goods status (e.g., a condition of goods being delivered and a loading status);
generating a completion message for the loading/unloading of the goods;
notifying the DRSP 200 of the completion of the loading/unloading of the goods;
generating a goods handling request message when the DR 300 is waiting to load/unload the goods at a pick-up location or a delivery location; and
transmitting the goods handling request message to the DRSP 200 when the loading/unloading is required.

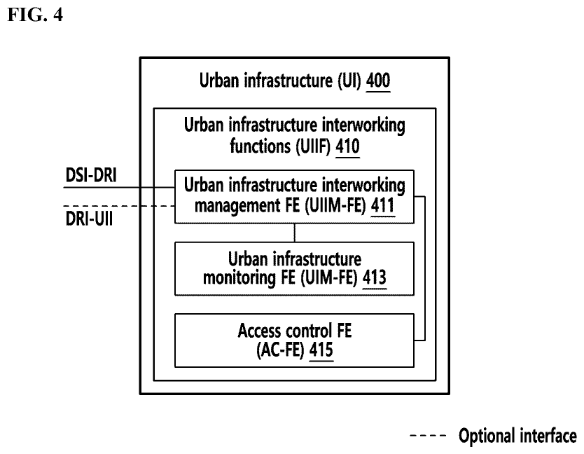

FIG. 4 is a diagram illustrating an urban infrastructure according to an embodiment.

Referring to FIG. 4, the UI 400 may include facilities (e.g., elevators, gates, communal entrances, or electric charging stations) that need to be used, accessed, and/or passed by the DR 300 to deliver goods. In the present disclosure, the UI 400 may be a device (e.g., a server) that manages the UI 400. The UI 400 may interwork directly with the DR 300 and the DRSP 200.

The UI 400 may share information (e.g., identifier, capability, or location) on the UI 400 with the DRSP 200.

The UI 400 may notify the DRSP 200 of whether access by the DR 300 is approved. The UI 400 may request the DRSP 200 to transmit information on goods loaded on the DR 300.

The UI 400 may interwork directly with the DRSP 200. The UI 400 may interwork with the DRSP 200 through another system (e.g., a building management system or an external infrastructure management service system).

The UI 400 may interwork directly with the DR 300 near the UI 400.

In response to a request from the DRSP 200, the UI 400 may provide information on the UI 400 (e.g., a service status, availability, a breakdown, or inspection) to the DRSP 200.

The UI 400 may include the UIIF 410. In the UI 400, interfaces for a delivery service may include DSI-UII and DRI-UII. The DSI-UII may be an interface between the UIIM-FE 411 and the DSIM-FE 211. The DRI-UII may be an interface between the UIIM-FE 411 and the DRIM-FE 311.

The UIIF 410 may provide a function for interworking with the DRSP 200 and the DR 300. The UIIF 410 may interwork with the DSIF 210 of the DRSP 200 and the DRIF 310 of the DR 300.

The UIIF 410 may include the UIIM-FE 411, an urban infrastructure monitoring functional entity (UIM-FE) 413, and an access control functional entity (AC-FE) 415.

The UIIM-FE 411 may perform an operation related to UI interworking management. For example, the operation related to UI interworking management may include:
sharing information (e.g., identifier, capability, or location) on an urban infrastructure with the DRSP 200;
interworking directly with the DRSP 200 or indirectly through another system, such as a building management system or an external infrastructure management service system; and
interworking directly with the DR 300 in a near field.

The UIM-FE 413 may perform an operation related to UI monitoring. For example, the operation related to UI monitoring may include:
collecting an infrastructure status (e.g., a service status, availability, a breakdown, or inspection); and
notifying the DRSP 200 of the infrastructure status.

The AC-FE 415 may perform an operation related to access control. For example, the operation related to access control may include:
notifying the DR 300 of a result of an access request to the UI 400; and
when the DR 300 accesses the UI 400, requesting delivery information from the DRSP 200.

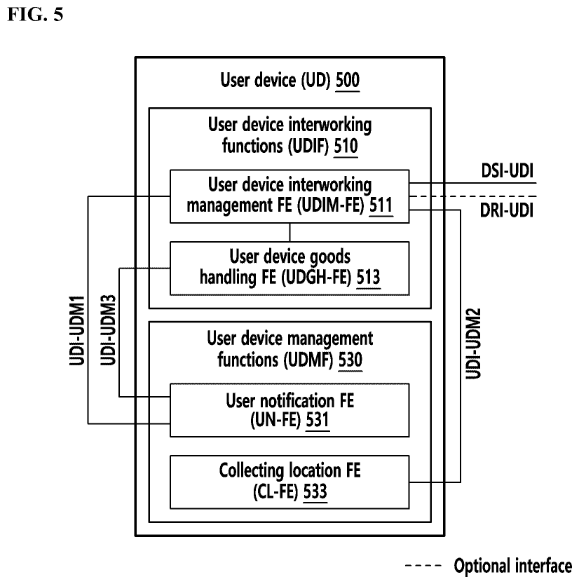

FIG. 5 is a diagram illustrating a user device according to an embodiment.

Referring to FIG. 5, the UD 500 may include one or more terminals. For example, the UD 500 may include at least one of a device of a delivery requester, a device related to the loading of the goods, and a device related to the unloading of the goods. The device may include an electronic device, such as a mobile device and a computing device, that is operated by a user and/or an unattended electronic device that may store and/or manage the goods. The UD 500 may interwork directly with the DRSP 200 and the DR 300.

The UD 500 may provide a function (e.g., a user interface) of receiving a delivery request from the user and providing the user with delivery status information.

The UD 500 may transmit delivery information input by the user to a delivery service provider 200.

The UD 500 may collect the location information of the UD 500.

When receiving information that needs to be confirmed or processed by the user, the UD 500 may notify the user of the reception of the information by using various means (e.g., sound, vibration, or light).

The UD 500 may interact directly with the DR 300 near the UD 500. For example, the UD 500 may interwork directly with the DR 300 when the DR 300 is located within a preset distance from the UD 500.

When receiving a request for the loading or unloading of the goods from the DRSP 200, the UD 500 may notify the user (e.g., a person in charge of loading or a receiver) of the reception of the request.

The UD 500 may notify the DRSP 200 that the loading or unloading of the goods has been completed.

The UD 500 may include the UDIF 510 and the UDMF 530. In the UD 500, interfaces for a delivery service may include UDI-UDM1, UDI-UDM2, UDI-UDM3, DSI-UDI, and DRI-UDI. The UDI-UDM1 may be an interface between the UDIM-FE 511 and a user notification functional entity (UN-FE) 531. The UDI-UDM2 may be an interface between the UDIM-FE 511 and a collecting location functional entity (CL-FE) 533. The UDI-UDM3 may be an interface between a user device goods handling functional entity (UDGH-FE) 513 and the UN-FE 531. The DSI-UDI may be an interface between the UDIM-FE 511 and the DSIM-FE 211. The DRI-UDI may be an interface between the UDIM-FE 511 and the DRIM-FE 311.

The UDIF 510 may provide a function for interworking with the DRSP 200, the DR 300, and the UDMF 530. The UDIF 510 may interwork with the UDMF 530, the DSIF 210 of the DRSP 200, and the DRIF 310 of the DR 300.

The UDIF 510 may include the UDIM-FE 511 and the UDGH-FE 513.

The UDIM-FE 511 may perform an operation related to UD interworking management. The operation related to UD interoperability management may include:
receiving a delivery request from a user;
notifying the DRSP 200 of the delivery request; and
interworking with the DR 300 in a near field, if necessary.

The UDGH-FE 513 may perform an operation related to goods handling. For example, the operation related to goods handling may include:
generating a completion message for loading/unloading of goods;
notifying the DRSP 200 of completion of the loading/unloading of goods;
collecting a goods status (e.g., a condition of goods being delivered and a loading status) and sharing the goods status with the DRSP 200; and
when receiving a request for the loading/unloading of goods, notifying a responsible entity performing a loading/unloading function.

The UDMF 530 may provide a function for interworking with the UDIF 510. The UDMF 530 may interwork with the UDIF 510.

The UDMF 530 may include the UN-FE 531 and the CL-FE 533.

The UN-FE 531 may perform an operation related to a user notification. For example, the operation related to a user notification may include:
when receiving information that needs to be confirmed or processed, notifying the user through means, such as sound, vibration, or light; and
displaying a delivery status to the user.

The CL-FE 533 may provide an operation related to location collection. For example, the operation related to location collection may include:
acquiring own location information.

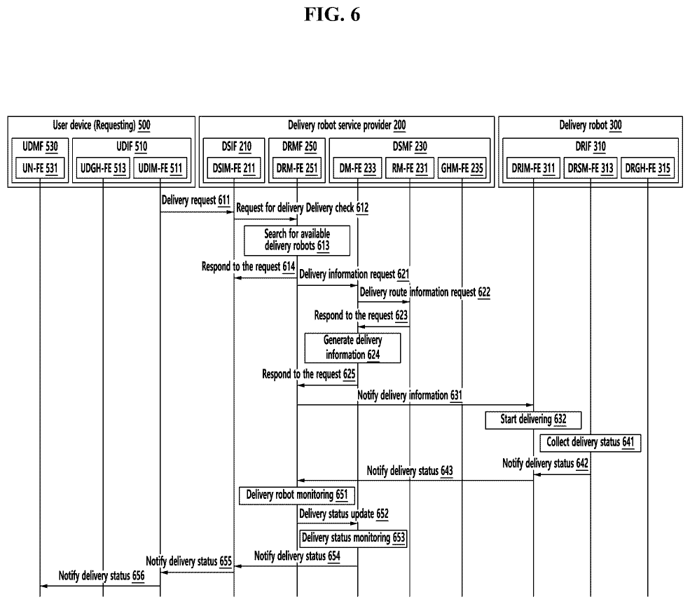

FIG. 6 illustrates a workflow for a delivery request and a delivery start in a user device according to an embodiment.

In operations 611 to 616, the UDIM-FE 511 of the UD 500 may transmit a request for goods delivery to the DRSP 200. The DRSP 200 may check whether the DR 300 is available and may notify the UN-FE 531 of the UD 500 of approval of the delivery request.

In operations 621 to 625, after generating delivery information including delivery route information, the DRM-FE 251 of the DRSP 200 may assign the DR 300 in response to the delivery request.

In operations 631 and 632, the DRM-FE 251 of the DRSP 200 may notify the DRIM-FE 311 of the DR 300 of the delivery information. The DR 300 may start delivery.

In operations 641 to 643, during the delivery, the DRSM-FE 313 may collect a delivery status (e.g., a current direction and location, a robot and battery status, etc.) and may notify the DRSP 200.

In operations 651 to 656, based on the received notification, the DM-FE 233 may monitor the delivery status and notify the UN-FE 531 of the UD 500.

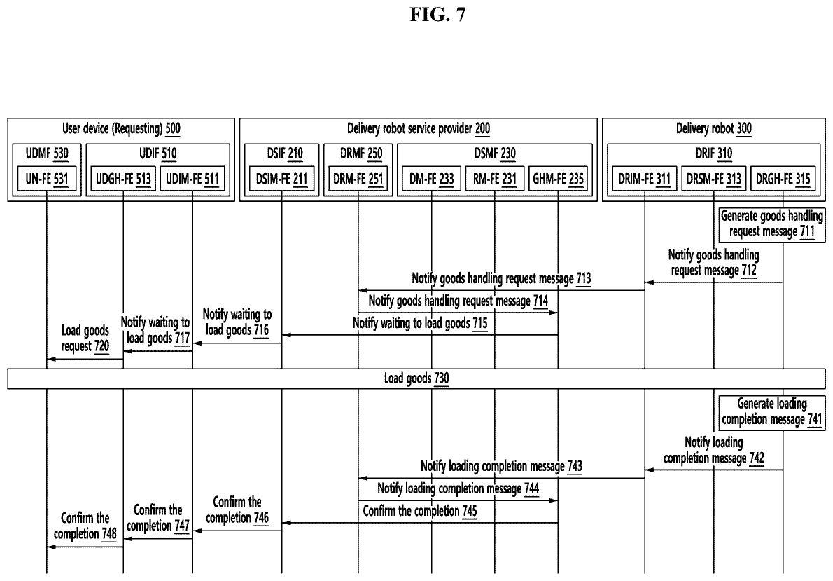

FIG. 7 illustrates a workflow for receiving a notification on completion of loading goods from a delivery robot according to an embodiment.

In operations 711 to 717, the DRGH-FE 315 of the DR 300 may notify the UD 500 through the DRSP 200 when the DR 300 is waiting to load goods at a pick-up location.

In operation 720, based on the received notification, the UDGH-FE 513 of the UD 500 may transmit a request to load the goods to the UN-FE 531.

In operation 730, the DR 300 may load the goods at the pick-up location.

In operations 741 to 748, when the loading is completed, the DRSP 200 may receive a completion message from the DR 300 and may then notify the UN-FE 531 of the UD 500.

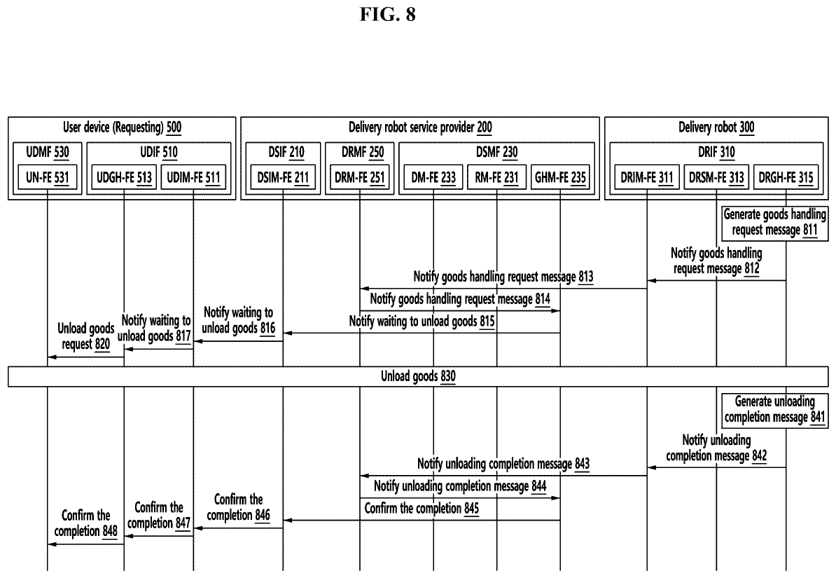

FIG. 8 illustrates a workflow for receiving a notification on completion of unloading goods from a delivery robot according to an embodiment.

In operations 811 to 817, the DRGH-FE 315 of the DR 300 may notify the UD 500 through the DRSP 200 when the DR 300 is waiting to unload goods at a delivery location.

In operation 820, based on the received notification, the UDGH-FE 513 of the UD 500 may transmit a request to unload the goods to the UN-FE 531.

In operation 830, the DR 300 may unload the goods at the delivery location.

In operations 841 to 848, when the unloading is completed, the DRSP 200 may receive a completion message from the DR 300 and may notify the UN-FE 531 of the UD 500.

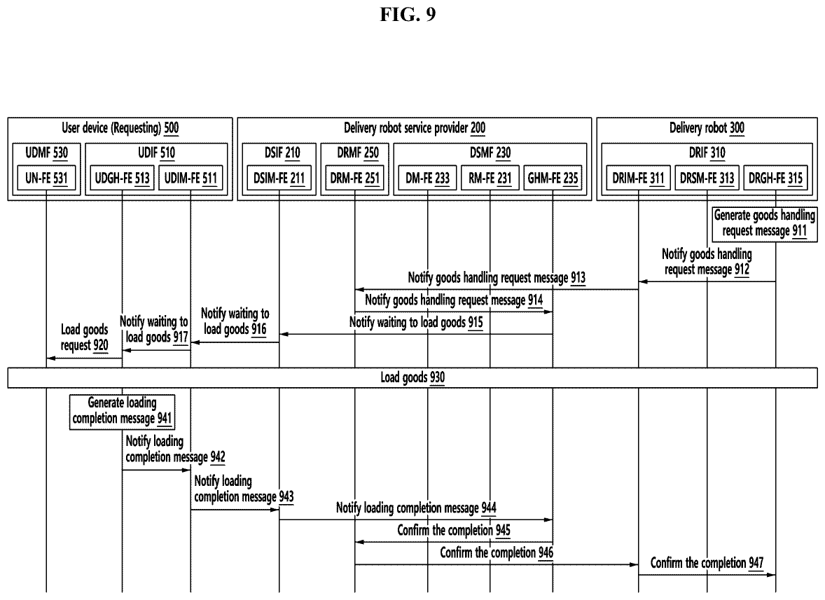

FIG. 9 illustrates a workflow for receiving a notification on completion of loading goods in a user device according to an embodiment.

In operations 911 to 917, the DRGH-FE 315 of the DR 300 may notify the UD 500 through the DRSP 200 when the DR 300 is waiting to load goods at a pick-up location.

In operation 920, based on the received notification, the UDGH-FE 513 of the UD 500 may transmit a request to load the goods to the UN-FE 531.

In operation 930, the DR 300 may load the goods at the pick-up location.

In operations 941 to 947, when the loading is completed, the DRSP 200 may receive a completion message from the UD 500 and may notify the DRIM-FE 311 of the DR 300.

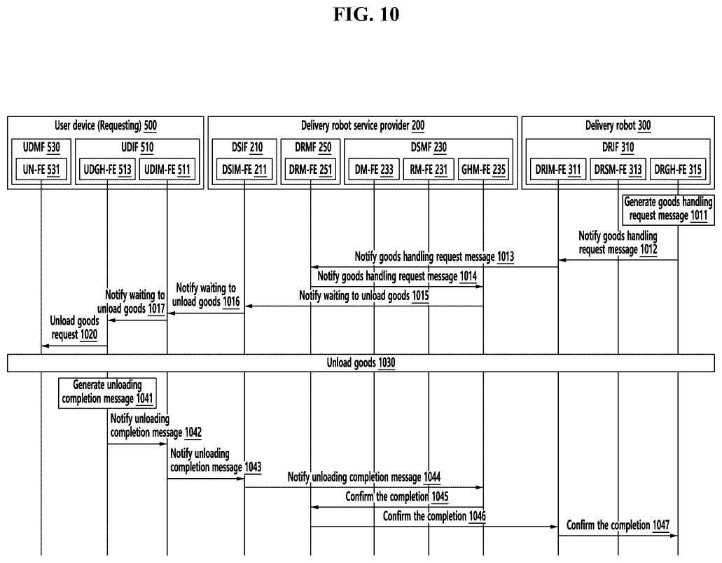

FIG. 10 illustrates a workflow for receiving a notification on completion of unloading goods in a user device according to an embodiment.

In operations 1011 to 1017, the DRGH-FE 315 of the DR 300 may notify the UD 500 through the DRSP 200 when the DR 300 is waiting to unload goods at a delivery location.

In operation 1020, based on the received notification, the UDGH-FE 513 of the UD 500 may transmit a request to unload the goods to the UN-FE 531.

In operation 1030, the DR 300 may unload the goods at the delivery location.

In operations 1041 to 1047, when the unloading is completed, the DRSP 200 may receive a completion message from the UD 500 and may notify the DRIM-FE 311 of the DR 300.

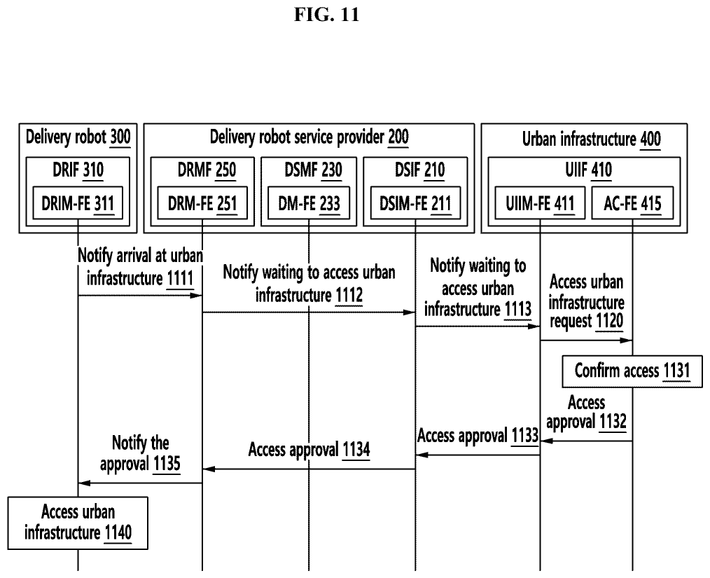

FIG. 11 illustrates a workflow for interworking between a delivery robot and an urban infrastructure according to an embodiment.

In operations 1111 to 1113, the DRIM-FE 311 may notify the UIIM-FE 411 through the DRSP 200 when the DR 300 is waiting in the UI 400.

In operation 1120, based on the received notification, the UIIM-FE 411 may transmit a request to the AC-FE 415 such that the DR 300 may access the UI 400.

In operations 1131 to 1135, when receiving access approval from the AC-FE 415, the UIIM-FE 411 may notify the DRIM-FE 311 through the DRSP 200.

In operation 1140, the DR 300 may access the UI 400.

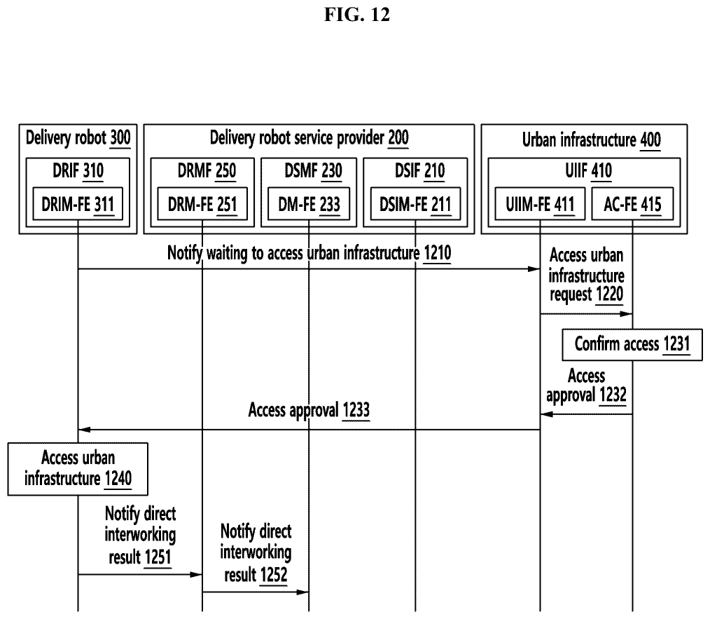

FIG. 12 illustrates a workflow for interworking between a delivery robot and an urban infrastructure according to an embodiment.

In operation 1210, the DRIM-FE 311 may notify directly the UIIM-FE 411 when the DR 300 is waiting near the UI 400.

In operation 1220, based on the received notification, the UIIM-FE 411 may transmit a request to the AC-FE 415 such that the DR 300 may access the UI 400.

In operations 1231 to 1233, when receiving access approval from the AC-FE 415, the UIIM-FE 411 may notify the DRIM-FE 311.

In operation 1240, the DR 300 may access the UI 400.

In operations 1251 and 1252, the DRIM-FE 311 may notify an interworking result directly to the DM-FE 233 through the DRM-FE 251 of the DR 300.

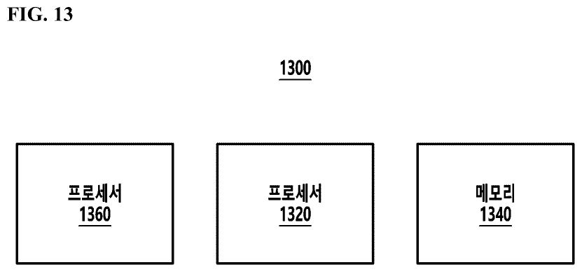

FIG. 13 is a schematic block diagram illustrating an apparatus according to an embodiment.

Referring to FIG. 13, according to an embodiment, an apparatus 1300 may include a processor 1320, a memory 1340, and a communication module 1360.

The apparatus 1300 may be the DRSP 200 or the DR 300 described with reference to FIGS. 1 to 12. The memory 1340 may store instructions (or programs) executable by the processor 1320.

For example, the instructions may include instructions for executing an operation of the processor 1320 and/or an operation of each component of the processor 1320. The memory 1340 may include one or more computer-readable storage media.

The memory 1340 may include non-volatile storage elements (e.g., a magnetic hard disk, an optical disc, a floppy disc, a flash memory, an electrically programmable memory (EPROM), and an electrically erasable and programmable memory (EEPROM)). The memory 1340 may be a non-transitory medium. The term “non-transitory” may indicate that a storage medium is not embodied in a carrier wave or a propagated signal.

However, the term “non-transitory” should not be interpreted to mean that the memory 1340 is non-movable. The processor 1320 may process data stored in the memory 1340.

The processor 1320 may execute computer-readable code (e.g., software) stored in the memory 1340 and instructions triggered by the processor 1320. The processor 1320 is a hardware-implemented data processing device having a circuit that is physically structured to execute desired operations.

For example, the desired operations may include code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA). The processor 1320 may cause the apparatus 1300 to perform one or more operations by executing the code, instructions, and/or applications stored in the memory 1340. The operations performed by the apparatus 1300 may be substantially the same as the operations performed by the DRSP 200 or the DR 300 described with reference to FIGS. 1 to 12.

Accordingly, the repeated description thereof is omitted. The communication module 1360 may establish a communication channel (e.g., a wireless communication channel) for communication. The communication module 1360 may support the communication through the established communication channel. The communication module 1360 may include one or more communication processors configured to support direct (or wired) communication or wireless communication.

The communication module 1360 may include a wireless communication module (e.g., a cellular communication module, a short-range wireless communication module, or a global navigation satellite system (GNSS) communication module) or a wired communication module 1794 (e.g., a local area network (LAN) communication module, or a power line communication (PLC) module). A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

1. An operating method of a delivery robot service provider, the operating method comprising:
receiving a delivery request from a user device;
generating delivery information on the delivery request;
assigning a delivery robot that performs the delivery request;
transmitting the delivery information to the delivery robot; and
sharing a current location of the delivery robot and a loading status of goods with the delivery robot service provider while the delivery robot is delivering the goods according to the delivery information.

2. The operating method of claim 1, wherein the delivery information comprises:
at least one of a pick-up location of the goods, a delivery location of the goods,
a delivery time of the goods, information on an infrastructure that the delivery robot needs to interwork with for the delivery of the goods, a delivery route of the goods, and a type of the goods.

3. The operating method of claim 1, wherein
the delivery robot service provider retains information on an infrastructure that interworks with the delivery robot.

4. The operating method of claim 1, further comprising:
interworking with an infrastructure located on a delivery route of the goods.

5. The operating method of claim 4, further comprising:
determining an access priority to the infrastructure between the delivery robot and another delivery robot based on a presence of the other delivery robot competing with the delivery robot to access the infrastructure.

6. The operating method of claim 5, wherein the determining comprises:
determining the access priority by interworking with another delivery robot service provider when the other delivery robot is managed by the other delivery robot service provider.

7. The operating method of claim 1, further comprising:
transmitting a loading status of the goods or an unloading status of the goods to a corresponding user device.

8. An apparatus for managing a delivery robot, the apparatus comprising:
a processor; and
a memory storing instructions,
wherein, when the instructions are executed by the processor, the instructions cause the apparatus to perform a plurality of operations, and
the plurality of operations comprises:
receiving a delivery request from a user device;
generating delivery information on the delivery request;
assigning a delivery robot that performs the delivery request;
transmitting the delivery information to the delivery robot; and
sharing a current location of the delivery robot and a loading status of goods with the delivery robot service provider while the delivery robot is delivering the goods according to the delivery information.

9. The apparatus of claim 8, wherein the delivery information comprises:
at least one of a pick-up location of the goods, a delivery location of the goods,
a delivery time of the goods, information on an infrastructure that the delivery robot needs to interwork with for the delivery of the goods, a delivery route of the goods, and a type of the goods.

10. The apparatus of claim 8, wherein the apparatus comprises:
an apparatus that retains information on an infrastructure that interworks with the delivery robot.

11. The apparatus of claim 8, wherein the plurality of operations further comprises:
interworking with an infrastructure located on a delivery route of the goods.

12. The apparatus of claim 11, wherein the plurality of operations further comprises:
determining an access priority to the infrastructure between the delivery robot and another delivery robot based on a presence of the other delivery robot competing with the delivery robot to access the infrastructure.

13. The apparatus of claim 12, wherein the determining comprises:
determining the access priority by interworking with another delivery robot service provider when the other delivery robot is managed by the other delivery robot service provider.

14. The apparatus of claim 8, wherein the plurality of operations further comprises:
transmitting a loading status of the goods or an unloading status of the goods to a corresponding user device.
